(19) United States
(12) Patent Application Publication
(10) Pub. No.: US 2019/0197538 A1
(43) Pub. Date: Jun. 27, 2019

(54) Systems and Methods for Providing Services to Network Traffic

(71) Applicant: MASTERCARD INTERNATIONAL INCORPORATED, Purchase, NY (US)

(72) Inventors: Alexandra Hamon, St. Louis, MO (US); Sharon Mohrlock, St. Charles, MO (US); Winifred Elizabeth House, Troy, MO (US)

(21) Appl. No.: 15/851,117

(22) Filed: Dec. 21, 2017

(51) Int. Cl. G06Q 20/40; G06Q 20/10; G06Q 20/20; G06Q 30/06

(52) U.S. Cl. CPC G06Q 20/405; G06Q 30/06; G06Q 20/20; G06Q 20/102

(57) ABSTRACT

Systems and methods are provided identifying interchange rate designators for network transactions. An exemplary method includes receiving, at a computing device, details of a network transaction associated with an entity where the details include a region identifier for the entity. The computing device searches in a data structure for one or more of the details of the network transaction and identifies an interchange rate designator based on the one or more details of the network transaction. The method further includes causing the identified interchange rate designator to be included in a clearing batch file for the network transaction, whereby the network transaction may be submitted for clearing and settlement with the identified interchange rate designator associated with the network transaction.

### FIELD

The present disclosure generally relates to systems and methods for providing services to network traffic, and in particular, to systems and methods for providing such services, which identify designators associated with the network traffic and where the network traffic includes parameters associated with the designators.

### BACKGROUND

This section provides background information related to the present disclosure which is not necessarily prior art.

Network transactions are known to be initiated by different users in different regions and/or under different circumstances. For example, a network transaction may be initiated by a consumer at a restaurant merchant in New York, while a different network transaction may be initiated by a different consumer at a travel merchant in Denmark. When the different transactions are initiated, the different circumstances associated with the transactions are provided as parameters within transaction data for the transactions. When processing the transactions, acquirers of the transactions are known to apply one or more rates to the transactions, such as, for example, interchange rates, and/or designators associated with one or more of the rates, based on logic employed by the acquirers in clearing or otherwise processing the transactions.

### DRAWINGS

The drawings described herein are for illustrative purposes only of selected embodiments and not all possible implementations, and are not intended to limit the scope of the present disclosure:

FIG. 1 illustrates an exemplary system for use in identifying interchange rate designators for payment account transactions;

FIG. 2 is a block diagram of an exemplary computing device that may be used in the system of FIG. 1; and

FIG. 3 is an exemplary method, which may be implemented via the system of FIG. 1, for use in identifying interchange rate designators for payment account transactions.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Payment account transactions are often made by consumers in various different regions and with various different merchants. While the regions of the transactions may be inherent in the locations of the merchants, other aspects of the transactions may be altered, such as, for example, authentication of the consumers involved in the transactions, payment account types, etc. In connection therewith, when the payment account transactions are routed through payment networks, for example, one or more interchange rates are applied, which are dependent on such aspects of the transactions. Acquirers involved in the transactions are then tasked with including interchange rate designators (IRDs) in the transactions, as associated with the appropriate interchange rates to be applied for the transactions. However, from time to time, the interchange rate designators may be incorrect, as the criteria associated with the interchange rate designators sometimes changes or may be onerous to evaluate. When the interchange rate designator is incorrect, it may lead to the acquirer or other party associated with the transaction paying a higher than required interchange rate, or, in some instances, may cause the transaction to be declined or defaulted to a standard interchange rate designator (generally, a higher rate than the rate for which the transaction would have qualified).

Uniquely, the systems and methods herein provide for identification of interchange rate designators for payment account transactions. In particular, for example, an interchange rate engine may be employed to identify an interchange rate designator with the lowest associated rate for a given transaction and/or group of transactions, especially for transactions in different regions, and then impose the interchange rate designator in a clearing file or inform an associated acquirer of the interchange rate designator. Additionally, or alternatively, the interchange rate engine may provide advice messages to the acquirer or others, which indicate prior transactions assigned with interchange rate designator, where other interchange rate designators may have provided a lower interchange rate. What's more, the interchange rate engine may provide advice messages and/or reports related to opportunities of the acquirer to reduce the cost associated with the payment account transaction(s), through more suitable interchange rate designators. In this manner, the acquirer is provided with alternate services, which depart from the conventional, to improve and/or optimize the selection, use and/or identification of interchange rate designators.

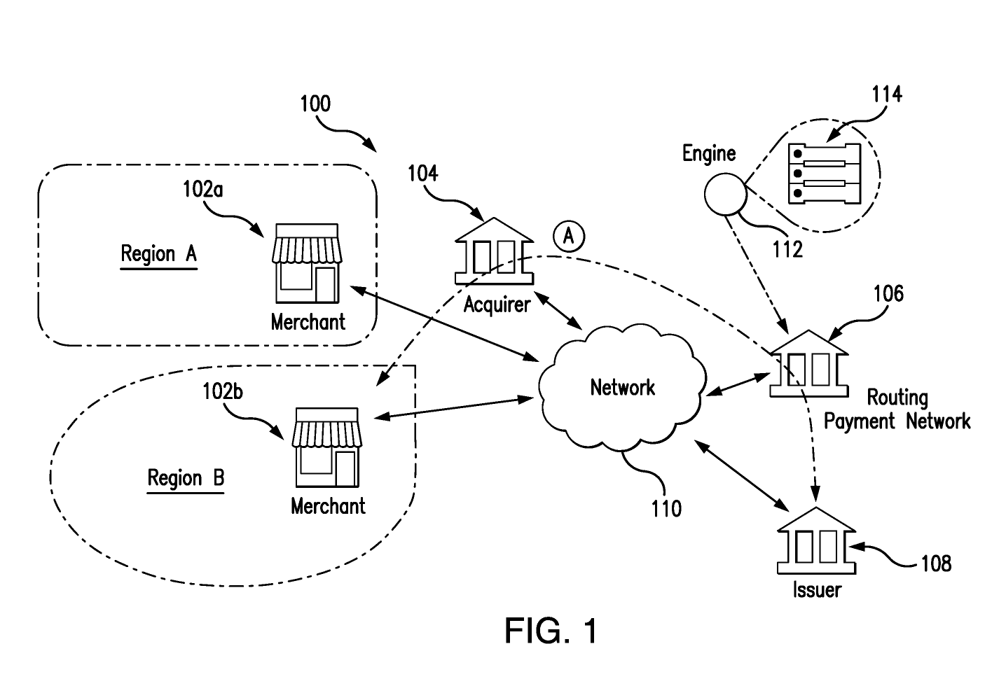

FIG. 1 illustrates an exemplary system 100 in which one or more aspects of the present disclosure may be implemented. Although the system 100 is presented in one arrangement, other embodiments may include systems arranged otherwise depending, for example, on a number of merchants, acquirers, issuers, payment networks, networks, and/or regions, included in the systems and interactions therebetween, etc.

In the illustrated embodiment, the system 100 generally includes two merchants 102a-b, an acquirer 104, a payment network 106, and an issuer 108, each coupled to (and in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirer 104 and the issuer 108, and, separately, the public Internet, which is accessible as desired to the merchants 102a-b, the acquirer 104, etc.

The merchants 102a-b in the system 100 are generally associated with products (e.g., goods and/or services, etc.) available for purchase by one or more consumers. The merchants 102a-b may offer the products for sale to one or more consumers, for example, through physical locations and/or through virtual locations, etc. In addition in the system 100, the merchant 102a is located in a first region (Region A), while the merchant 102b is located in a second region (Region B). And, while neither the acquirer 104, the payment network 106, nor the issuer 108 (or other parts of the system 100) are disposed within the dotted enclosures designating the two Regions A and B, each may be located in one of the Regions A and B, or in one or more different regions not shown in FIG. 1 in other embodiments.

The issuer 108 is provided in the system 100, potentially along with various other issuers (not shown), to issue payment accounts to multiple different consumers (also not shown). The payment accounts are used, then, by the consumer to facilitate payment account transactions, or network transactions, with the merchants 102a-b (and potentially with other merchants). It should be appreciated that different types of payment accounts may be issued by the issuer 108, and that the accounts may be registered to certain services and/or membership programs, or not, through the consumers' registration with the accounts or as a benefit of the accounts. For example, the payment accounts may be associated with various different or particular product codes (e.g., groceries, fuel, etc.), merchant category codes (e.g., grocery stores, gas stations, etc.), processing codes, account status (e.g., indicating whether or not the accounts have past due balances, etc.) timeliness (e.g., indicating whether or not account balances are paid in a timely manner, etc.), etc. Such features of the payment accounts may affect interchange rates for transactions performed using the payment accounts (and, thus, the rates associated with the interchange rate designators described herein (e.g., the features recited above may be used to calculate the rates associated with the interchange rate designators described herein, etc.)).

In one example transaction, a consumer presents a payment device associated with his/her payment account, as issued by the issuer 108, to the merchant 102b to fund a transaction for a product. The consumer may also be asked to authenticate himself/herself (e.g., through a PIN, signature, biometric, etc.). Then, or in connection therewith, the merchant 102b, at a point of sale (POS) device, for example, compiles and transmits an authorization message for the transaction (e.g., an authorization request message, etc.). The authorization message may include, for example, a payment account number for the payment account (e.g., a primary account number (PAN), etc.), a transaction amount, a merchant ID for the merchant 102b, a currency code, a location identifier, etc. Because the merchant 102b is associated with the acquirer 104 in this example, the authorization message is transmitted, along path A in FIG. 1, to the acquirer 104, which, in turn, communicates the authorization message through the payment network 106 (e.g., through MasterCard®, VISA®, Discover®, American Express®, etc.) to the issuer 108. In response to the authorization message, the issuer 108 determines whether the transaction should be approved, for example, based on whether the payment account associated with the consumer (and identified in the authorization message) is in good standing and includes sufficient funds and/or credit to cover the transaction (based on the transaction amount included in the authorization request, etc.). After approving or declining the transaction, the issuer 108 transmits an authorization message (e.g., an authorization reply message, etc.) back, along path A, to the merchant 102, which permits the merchant 102 to complete the transaction, or, potentially, when declined, request alternative payment.

While the above transaction is described with reference to the merchant 102b of the system 100, it should be appreciated that a transaction initiated at the merchant 102a is substantially the same.

In connection with the above exemplary transaction involving the merchant 102b, and even with other transactions initiated at the merchants 102a-b, the acquirer 104 compiles clearing records, by which the transactions are settled between the merchant 102b (or the merchant 102a) and the consumers, with the appropriate fees paid to the acquirer 104, the payment network 106, and the issuer 108. Specifically, for example, fees associated with the above exemplary transaction may include one or more of an account fee based on the particular type of the payment account (e.g., where a different fee is applied based on whether the account is a credit account, a debit account, a prepaid account, etc.), a switching fee (e.g., a fee associated with routing the transaction information over the payment network 106, etc.), a shared service fee, a value added service fee, etc. (one or more of which may be used in connection with determining interchange rates for transactions in connection with interchange rate designators, etc.).

When the clearing records are received and organized at the acquirer 104, for a specified interval (e.g., daily, etc.), the clearing records are provided to the payment network 106 (e.g., in a batch file, etc.), which also receives like records from the issuer 108. Then, at some interval, the payment network 106 settles the transactions by causing transactions to and/or from accounts associated with the acquirer 104 and the issuer 108, etc. Thereafter, the payment account transactions, such as the one described above, are complete.

While two merchants 102a-b, two Regions A and B, one acquirer 104, one payment network 106, and one issuer 108 are included in the system 100 illustrated in FIG. 1, it should be appreciated that any number of these parts (and their associated components) may be included in the system 100, or may be included as a part of systems in other embodiments, consistent with the present disclosure.

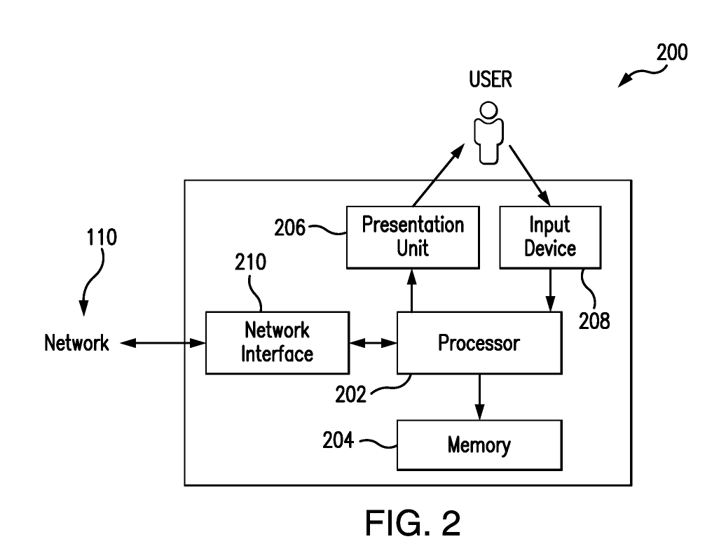

FIG. 2 illustrates an exemplary computing device 200 that can be used in the system 100. The computing device 200 may include, for example, one or more servers, workstations, personal computers, laptops, tablets, smartphones, PDAs, POS devices, etc. In addition, the computing device 200 may include a single computing device, or it may include multiple computing devices located in close proximity or distributed over a geographic region, so long as the computing devices are specifically configured to function as described herein. In particular, in the exemplary system 100 of FIG. 1, each of the merchants 102a-b, the acquirer 104, the payment network 106, and the issuer 108 may include, or may be implemented in, at least one computing device consistent with the computing device 200 and coupled to the network 110. However, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, interchange rate designators, interchange rate criteria (including rates, etc.), and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In addition in the exemplary embodiment, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information (e.g., advisements related to interchange rate designators, etc.), either visually or audibly to a user of the computing device 200 as part of the system 100, etc. Various interfaces (e.g., as defined by network-based applications, webpages, short message service (SMS) messages, emails, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 may include multiple devices.

The computing device 200 also includes an input device 208 that receives inputs from the user (i.e., user inputs) such as, for example, selections of different interchange rate designators, etc. The input device 208 is coupled to (and is in communication with) the processor 202 and may include, for example, a keyboard, a pointing device, a touch sensitive panel (e.g., a touch pad or a touch screen, etc.), another computing device, and/or an audio input device. Further, in various exemplary embodiments, a touch screen, such as that included in a tablet, a smartphone, or similar device, may behave as both the presentation unit 206 and the input device 208.

Further, the illustrated computing device 200 includes a network interface 210 coupled to (and in communication with) the processor 202 and the memory 204. The network interface 210 may include, without limitation, a wired network adapter, a wireless network adapter, a mobile network adapter, or other device capable of communicating to/with one or more different networks, including the network 110. Further, in some exemplary embodiments, the computing device 200 may include the processor 202 and one or more network interfaces (including the network interface 210) incorporated into or with the processor 202.

Referring again to FIG. 1, the system 100 further includes an interchange rate engine 112 and an interchange rate data structure 114 coupled to the engine 112. And, each of the interchange rate engine 112 and the interchange rate data structure 114 is embodied in a computing device consistent with computing device 200. In the illustrated embodiment, the interchange rate engine 112 and the interchange rate data structure 114 are associated with the payment network 106 as indicated by the dotted line (and may be embodied in a computing device 200 associated therewith, or in a separate computing device). That said, the interchange rate engine 112 and/or the interchange rate data structure 114 may be one or more standalone computing devices and/or may each exist in one or more separate computing devices in other system embodiments. The interchange rate engine 112 is configured, by executable instructions, to perform the operations described herein.

The interchange rate data structure 114 includes multiple different interchange rate designators (or, potentially, interchange rates) and criteria associated with each of the different interchange rate designators. Table 1 illustrates a number of interchange rate designators (IRDs) and the associated criteria as may be included in the interchange rate data structure 114.

TABLE 1

| IRD | Criteria |
|---|---|
| HQ | Spend qualified at restaurant MCC 5812, |
| | registered PAN |
| HA-A | Spend qualified in Region A, registered PAN |
| HA-B | Spend qualified in Region B, registered PAN |
| HA | Registered PAN |
| 79-A | Transaction in Region A, Full Universal |
| | Cardholder Authentication Field (UCAF) |
| | (fully authenticated transaction) |
| 79 | Full Universal Cardholder Authentication Field |
| | (UCAF) (fully authenticated transaction) |
| Standard | All other transactions |
| . . . | . . . |

In connection therewith, the IRD HQ may represent a world high value restaurant standard applicable for an account having a unique 16-digit PAN registered and spend qualified for an Account Level Management Program: World High Value service. And, the IRD HA may represent a world high value standard applicable for an account having a unique 16-digit PAN registered and spend qualified for an Account Level Management Program: World High Value service. Transactions may qualify for the IRD HQ when the PAN is registered in the given service and the transaction criteria is with a restaurant (e.g., MCC 5812, etc.), and when any additional criteria defined by the IRD HQ are satisfied (e.g., a total annual spend to the account of $50,000; any presentments, chargebacks, and arbitration chargebacks associated with the account do not exceed applicable time frames for such submission against the given IRD (e.g., satisfy a timeliness criteria, etc.); etc.). If the transaction criteria is not met as defined for the IRD HQ (i.e., the transaction is not with a restaurant), the transaction may be downgraded the IRD HA. With that said, as the criteria for the IRD HA and the IRD HQ are different, to receive the best rate possible, the transaction submitted with IRD HQ must have a restaurant MCC and may need to meet a timeliness criteria set forth on the HQ IRD. Alternately, for the IRD HA, there may not be any MCC or timeliness criteria set forth, but the corresponding rate may not be as lucrative.

Similarly, the IRD HA-A may again represent a world high value standard applicable for an account having a unique 16-digit PAN registered and spend qualified for an Account Level Management Program: World High Value service. Transactions may qualify for the IRD HA-A when the PAN is registered in the given service and the transaction criteria is with a merchant in a particular region (i.e., Region A), and when any additional criteria defined by the IRD HA-A are satisfied (e.g., a total annual spend to the account of $50,000; any presentments, chargebacks, and arbitration chargebacks associated with the account do not exceed applicable time frames for such submission against the given IRD (e.g., satisfy a timeliness criteria, etc.); etc.). If the transaction criteria is not met as defined for the IRD HA-A (i.e., the transaction is not with a merchant in Region A), the transaction may be downgraded the IRD HA (assuming the other criteria for the IRD HA are satisfied). And, the IRD HA-B may represent a world high value standard applicable for an account having a unique 16-digit PAN registered and spend qualified for an Account Level Management Program: World High Value service. Transactions may qualify for the IRD HA-B when the PAN is registered in the given service and the transaction criteria is with a merchant in a particular region (i.e., Region B), and when any additional criteria defined by the IRD HA-B are satisfied (e.g., a total annual spend to the account of $50,000; any presentments, chargebacks, and arbitration chargebacks associated with the account do not exceed applicable time frames for such submission against the given IRD (e.g., satisfy a timeliness criteria, etc.); etc.). If the transaction criteria is not met as defined for the IRD HA-B (i.e., the transaction is not with a merchant in Region B), the transaction may be downgraded the IRD HA (assuming the other criteria for the IRD HA are satisfied). In this manner, the interchange rate designators may be regional based.

Notwithstanding the above, it should be appreciated that interchange rate designators may depend on additional or different criteria than that included in Table 1. In addition, it should be appreciated that multiple other, different, additional, etc. interchange rate designators may be used in other embodiments.

In operation of the system 100, in a first aspect, the interchange rate engine 112 is configured to expose an application programming interface, or API, to the acquirer 104, and to determine an interchange rate designator for a given transaction in response to a request, from the acquirer 104, via the API. Specifically, at a time associated with clearing (e.g., when compiling a clearing batch file, or upon receipt of a clearing file from a merchant, etc.), the acquirer 104 is configured to submit a request for one or more interchange rates designators through the API associated with the engine 112. The request may, for example, include a clearing batch file having one or multiple transactions. The clearing batch file, or more generally, the request includes details of each the transactions, such as, for example, a merchant ID, a location or region (or identifier thereof (e.g., Region A, Region B, etc.)), a PAN (or other account number), a currency code, an account program indicator, an account product indicator, message type ID, a processing code, a card acceptor business (CAB) program, a timeliness indicator, an approval code, magnetic stripe data from authorization message, a trace ID, merchant MCC, an amount tolerance indicator, a card acceptor ID code, a card acceptor name and address, a payment network assigned ID, a financial detail addendum/1644, etc.

Upon receipt of the request, the engine 112 is configured to identify each of the transactions within the request and then, for each transaction, determine which interchange rate designators, as defined in the data structure 114, apply to the transaction (taking into account the details of each of the transactions). When an interchange rate designator is identified, the interchange rate engine 112 is configured to notify the acquirer 104 of the interchange rate designator (e.g., as an advisement message, etc.), per transaction, or per request, etc. In response, the acquirer 104 may be configured to append the interchange rate designators to one or more clearing files for the transaction(s) and to submit the clearing batch file (with the interchange rate designator(s) appended thereto) to the payment network 106 for clearing and settlement, etc.

In a second aspect, the acquirer 104 is configured to submit a clearing batch file to the payment network 106 for purposes of clearing and settlement, after applying interchange rate designators based on logic in the acquirer 104 or, potentially, without interchange rate designators. The cleating batch file includes multiple transactions associated with the merchants 102a-b, for example (again, where each of the merchants 102a-b is associated with the acquirer 104).

The payment network 106 is configured, in turn, to pass the clearing batch file to the interchange rate engine 112. In this aspect, the interchange rate engine 112 is configured to change and/or append one or more interchange rate designators to the clearing batch file prior to proceeding with clearing and/or settlement. Specifically, for each transaction included in the clearing batch file, the interchange rate engine 112 is configured to identify each of the transactions within the request and then, for each transaction, determine which interchange rate designator(s), as defined in the data structure 114, applies to the transaction (again taking into account the details of each of the transactions). When an interchange rate designator is identified, the interchange rate engine 112 is configured to append the interchange rate designator to the batch file for the given transaction (when an interchange rate designator is not already present), or to replace an existing interchange rate designator in the batch file when the designator is inconsistent with the designator identified by the interchange rate engine 112 (e.g., when the acquirer 104 appended an incorrect interchange rate designator to the batch file for the transaction, etc.). Then, once an interchange rate designator is identified for each transaction in the batch file by the interchange rate engine 112 (and changed, as needed), the interchange rate engine 112 is configured to pass the batch file to the payment network 106 for clearing and settlement, etc.

In this second aspect, rather than appending and/or changing interchange rate designators in the batch file for the acquirer 104, the interchange rate engine 112 may be configured to instead compile a report of interchange rate designators different from those included by the acquirer 104, per transaction or group of transactions, and to transmit the report to the acquirer 104. In this manner, the acquirer 104 is informed of changes in the interchange rate designators, or interchange rate designators that could have or should have been different in the submitted batch file, thereby affecting the interchange rate(s) paid by the acquirer 104, the merchants 102a-b, etc., for the specific transactions.

In a third aspect, the interchange rate engine 112 is configured to determine one or more interchange rate opportunities for transactions in the clearing batch file received from the acquirer 104, whereby a different interchange rate designator may be applied to one or more of the transactions.

Specifically in this aspect, the data structure 114 includes a number of rules associated with different rate-based opportunities. The rules may, for example, identify where an e-commerce transaction qualifies for a first interchange rate designator, based on the criteria, but would have qualified for a second interchange rate designator (i.e., associated with a lower rate) had the merchant 102a, for example, authenticated the consumer in connection with the transaction (e.g., IRD 79 in Table 1, etc.). In general, each of the rules is based on the criteria for the interchange rate designators, such as those included in Table 1. In this aspect, the interchange rate engine 112 is then configured to identify a transaction, in a request and/or in the clearing batch file, and to identify one or more different and/or better (e.g., by way of cost, etc.) interchange rate designators, based on the transaction being consistent with at least a portion of the criteria for the interchange rate designator(s). In particular, the interchange rate engine 112 may be configured to evaluate the criteria for each interchange rate designator against each of the give transactions and determine which provides a lowest total rate for the involved consumer, etc.

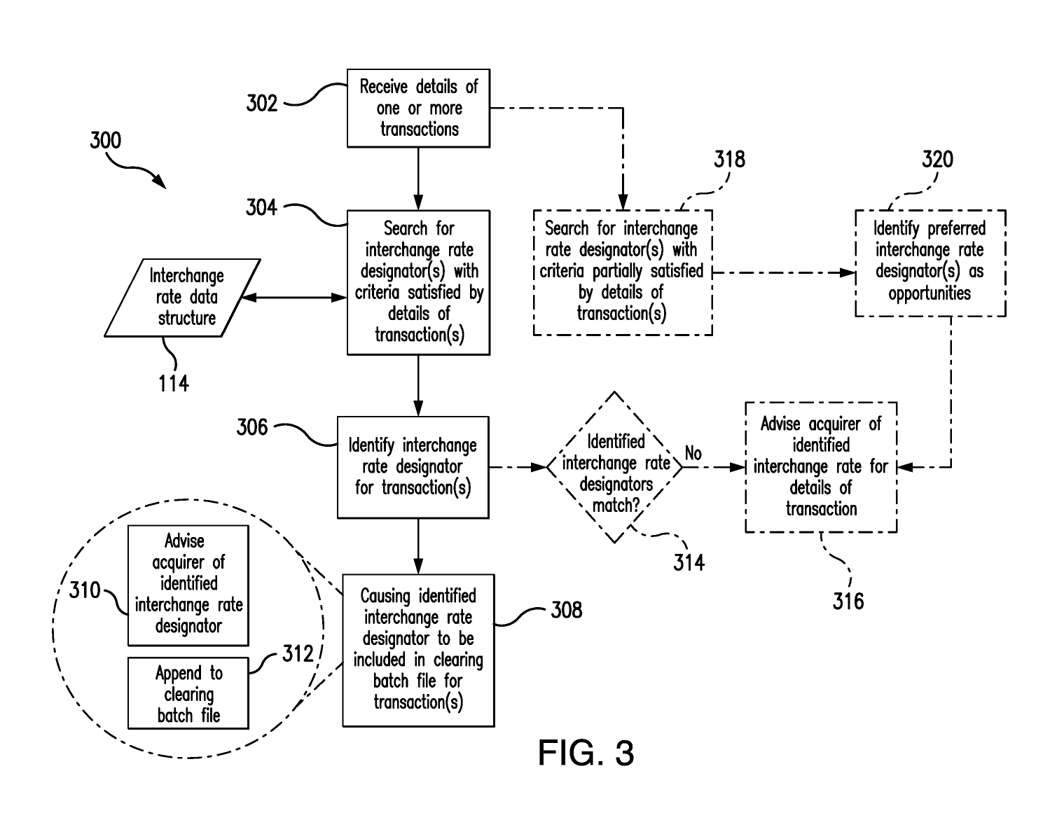

FIG. 3 illustrates an exemplary method 300 for use in identifying interchange rate designators for payment account transactions. The exemplary method 300 is described with reference to the system 100, as implemented in the acquirer 104 and the interchange rate engine 112, and further with reference to computing device 200. However, it should be understood that the method 300 is not limited to this configuration of the system 100, as the method 300 may be implemented, at least in part, in other parts in system 100, or in multiple other computing devices or systems. As such, the methods herein should not be understood to be limited to the exemplary system 100 or the exemplary computing device 200, and likewise, the systems and the computing devices herein should not be understood to be limited to the exemplary method 300.

At 302 in the method 300, the interchange rate engine 112 receives details of one or more transactions from the acquirer 104. The details may be received in a number of different ways. For example, prior to clearing, the acquirer 104 may send a request, via an API, to the interchange rate engine 112 to request interchange rate designators for one or more transaction identified in the request (whereby details for the one or more transactions are provided in the request). In another example, as part of clearing, the acquirer 104 may provide the details of the one or more transactions to the interchange rate engine 112 in a clearing batch file.

Regardless of how the details of the one or more transactions are received, the interchange rate engine 112 then searches, at 304, in the interchange rate data structure 114 based on the received transaction details. Specifically, for example, for each received transaction, the interchange rate engine 112 searches for one or more different interchange rate designators having criteria that are satisfied by the details of the transaction. In one exemplary embodiment, a detail of the transaction may include a region of the merchant involved in the transaction. In connection therewith, as part of the search at 304, the interchange rate engine 112 may search for one or more different interchange rate designators having criteria that matches the region of the merchant as well as having criteria that matches other details of the transaction. In another exemplary embodiment, a detail of the transaction may again include a region of the merchant involved in the transaction. In this embodiment, as part of the search at 304, the interchange rate engine 112 may initially filter all interchange rate designators in the interchange rate data structure 114 based on the region of the merchant (such that a reduced group of interchange rate designators is provided that all include the region of the merchant as a criteria). Then, the interchange rate engine 112 may search in the group of filtered interchange rate designators for one or more different interchange rate designators having criteria that matches other details of the transaction (whereby the region of the merchant is still used as criteria for identifying an interchange rate designator, but not necessarily as a particular search parameter in the underlying search). It should be appreciated that other details of the transaction may similarly be used to initially filter the interchange rate designators in the interchange rate data structure 114 in other embodiments.

And, based on the search and the details of the transactions relative to the criteria of the interchange rate designators, the interchange rate engine 112 identifies, at 306, an interchange rate designator for each of the one or more transactions. When the criteria of multiple interchange rate designators is satisfied by the details of a given transaction, the interchange rate engine 112 may then select one of the multiple interchange rate designators providing the lowest rate, based on a ranking of the interchange rate designators, etc. In one example, each available interchange rate designator may be associated with a numeric value in the data structure 114 (e.g., based on the rate associated therewith, based on use, based on other criteria provided by the payment network 106, the acquirer 104, the issuer 108, etc.). Then, when the criteria of multiple interchange rate designators is satisfied by the details of a given transaction, the interchange rate engine 112 selects the interchange rate designator with the lowest (or highest) associated numeric value.

As an example, details for a transaction may indicate that the transaction occurred in Region A, at merchant 102a, and that the payment account involved was a qualified spend credit account, and that the consumer was authenticated in connection with the transaction. As such, based on these details, the interchange rate engine 112 may determine that the transaction satisfies each of the criteria associated with the interchange rate designator 79-A in Table 1 above. In another example, details of the transaction may indicate that the transaction occurred in Region B, at merchant 102b (which is a restaurant merchant, having an MCC of 5812), while the consumer was not authenticated at the time of the transaction. Based on these details, the interchange rate engine 112 may determine that the transaction satisfies each of the criteria associated with the interchange rate designator HQ in Table 1 above. In a further example, details of the transaction may indicate that the transaction occurred in Region A, at merchant 102a (which is a restaurant merchant, having an MCC of 5812), and the consumer was authenticated at the time of the transaction. Based on these details, the interchange rate engine 112 may determine that the transaction satisfies each of the criteria associated with the interchange rate designators HQ, 79-A, and 79 in Table 1 above. In connection therewith, the interchange rate engine 112 may then determine that the interchange rate designator HQ has a lower numeric value assigned thereto (as compared to the interchange rate designators 79) (e.g., a better interchange rate for the consumer, etc.) and thus selects the interchange rate designators HQ for the given transaction.

Then in the method 300, once the interchange rate designator is identified, the interchange rate engine 112 causes, at 308, the identified interchange rate designator to be included in the request or in the clearing batch file for the given transaction (and, when the request or batch file includes multiple transactions, the above operations are repeated for each of the multiple transactions), as received from the acquirer 104 (at 302).

In connection therewith, when the details of the transaction(s) are received from the acquirer 104 via the request prior to clearing (e.g., in response to the API call, etc.) (i.e., prior to a first presentment), the interchange rate engine 112 may (as indicated by the dotted box in FIG. 3) advise the acquirer 104, at 310, of the identifier interchange rate designator(s), along with, for example, a transaction identifier. Thereafter, the acquirer 104 is then able to append the identified interchange rate designator for the transaction(s) in the clearing batch file and submit the same to the payment network 106 for clearing and/or settlement consistent with the identified interchange rate designator(s) (whereby the interchange rate engine 112 may also be viewed as effectively causing (via the acquirer 104) the identified rate designator(s) to be included in the clearing batch file). Alternatively, where the details of the transaction(s) are received from the acquirer 104 in connection with clearing (e.g., through a first presentment, etc.) at the payment network 106, for example, the interchange rate engine 112 may, at 312, append the identified interchange rate designator(s) to the clearing batch file, for the transaction(s), by directly adding the designator(s). In addition, in this scenario the interchange rate engine 112 may also provide an acknowledgement message back to the acquirer 104 of the interchange rate designator(s).

As part of the above discussion, it should be appreciated that the interchange rate designator for each transaction is used in the clearing process, whereby a transaction may be declined when the interchange rate designator includes a criteria, such as, for example, a registered PAN, and the PAN associated with the transaction is not registered (thereby requiring the acquirer 104 to reprocess the transaction, likely at the standard interchange rate designator). As such, the acquirer 104, in this example, relies on the interchange rate engine 112 to identify the proper and/or correct interchange rate designator for the transaction in order to avoid having to reprocess the transaction when the interchange rate designator identified by the acquirer 104 is incorrect.

Additionally (or optionally) in the method 300, where the acquirer 104 has already included one or more interchange rate designators in the clearing batch file prior to transmitting the clearing batch file to the payment network 106 and/or interchange rate engine 112 (or in the request to the interchange rate engine 112), the interchange rate engine 112 may determine if the interchange rate designator already included for each transaction matches the interchange rate designator identified by the interchange rate engine 112 in its search. And, if it does not, the interchange rate engine 112 may replace the prior interchange rate designator(s) with the identified interchange rate designator(s). Here, again, the interchange rate engine 112 may provide an acknowledgement message to the acquirer 104 of the replaced interchange rate designator(s). Thereafter, the payment network 106 is permitted to proceed with the clearing and settlement of the transactions, through use of the identified/updated interchange rate designator(s).

Specifically, for example, the interchange rate engine 112 may again receive details of a transaction, at 302, as part of clearing the transaction or apart therefrom. Here, though, the acquirer 104 has already associated an interchange rate designator with the transaction. In response, as above, the interchange rate engine 112 searches in the data structure 114, at 304, for one or more interchange rate designators with criteria matching the detail of the transaction, and identifies, at 306, an interchange rate designator(s) for the transaction. However, in this scenario, the interchange rate engine 112 (optionally, as indicated by the dotted lines in FIG. 3) determines, at 314, whether the identified interchange rate designator matches the interchange rate designator included for the transaction, and then, at 316, advises the acquirer 104 of the identified interchange rate designator when there is no match. Along with the identified interchange rate designator, the interchange rate engine 112 may further include the transaction detail and/or ID for the transaction, so that the acquirer 104 is able to identify the transaction for the interchange rate designator. What's more, the interchange rate engine 112 may include differences in the criteria for the identified interchange rate designator and the interchange rate designator originally included for the transaction by the acquirer 104. In this manner, the acquirer 104 is informed of interchange rate designators deviating from those identified by the interchange rate engine 112, whereupon the acquirer 104 may alter rules and/or logic employed thereby to assign the interchange rate designators.

Still further in the method 300 (or as another option, as indicated by the dotted lines in FIG. 3), upon receiving details of a transaction, at 302, the interchange rate engine 112 may search, at 318, for an interchange rate designator(s) with criteria at least partially satisfied by details of the transaction and then identify, at 320, a preferred interchange rate designator based on those with criteria that are at least partially satisfied. Specifically, here, when a transaction partially satisfies the criteria for an interchange rate designator (e.g., the details of the transaction fail to satisfy (or do not satisfy) all of the criteria for the interchange rate designator, etc.), and when that interchange rate designator is preferred over another interchange rate designate for the transaction, the interchange rate engine 112, in this example, after identifying the preferred interchange rate designator, may inform the acquirer 104 of the preferred interchange rate designator (e.g., as an opportunity, etc.), at 316, along with the unsatisfied criteria (but without the transaction being submitted for clearing and settlement with the identified interchange rate designator). In this manner, the acquirer 104 is permitted to evaluate the differences between the interchange rate designators for the transaction and consider whether, or not, to attempt to satisfy the unsatisfied criteria for subsequent transactions.

In one illustrative example, and with reference to Table 1, the interchange rate 79 requires authentication of a consumer in connection with a transaction. As such, when a transaction is initiated without such authentication, the acquirer 104 and/or the interchange rate engine 112 may identify the interchange rate designator Standard as applying to the transaction. As such, in the method 300, the interchange rate engine 112 may search, at 318, for interchange rate designators with partially satisfied criteria for the transaction, which includes the interchange rate designator 79, and then identify, at 320, the interchange rate designator 79 as being preferred to the interchange rate designator Standard due to an improved rate. The interchange rate engine 112 then advises the acquirer 104 of the preferred interchange rate designator 79 and the associated unsatisfied criteria, i.e., authentication of the consumer. The acquirer 104 may then decide to impose an authentication requirement, or not, for subsequent transactions at the merchants 102a-b.

Again, and as previously described, it should be appreciated that the functions described herein, in some embodiments, may be described in computer executable instructions stored on a computer-readable media, and executable by one or more processors. The computer-readable media is a non-transitory computer-readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving, at a computing device, details of a network transaction (e.g., a payment account transaction, etc.) associated with an entity (e.g., a merchant, etc.), the details including a region identifier for the entity; (b) searching, by the computing device, in a data structure associated with the computing device for one or more of the details of the network transaction; (c) identifying, by the computing device, based on the search in the data structure, an interchange rate designator based on the one or more details of the network transaction; and (d) causing the identified interchange rate designator to be included in a clearing batch file for the network transaction, whereby the network transaction is submitted for clearing and settlement with the identified interchange rate designator associated with the network transaction.

Exemplary embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for identifying interchange rate designators for network transactions, the method comprising:
receiving, at a computing device, details of a network transaction associated with an entity, the details including a region identifier for the entity;
searching, by the computing device, in a data structure associated with the computing device for one or more of the details of the network transaction;
identifying, by the computing device, based on the search in the data structure, an interchange rate designator based on the one or more of the details of the network transaction; and
causing the identified interchange rate designator to be included in a clearing batch file for the network transaction, whereby the network transaction is submitted for clearing and settlement with the identified interchange rate designator associated with the network transaction.

2. The computer-implemented method of claim 1, wherein receiving the details of the network transaction includes receiving a request from an acquirer associated with the entity; and
wherein causing the identified interchange rate designator to be included in the clearing batch file includes transmitting the identified interchange rate designator to the acquirer, thereby permitting the acquirer to append the identified interchange rate designator to the clearing batch file.

3. The computer-implemented method of claim 1, wherein receiving the details of the network transaction includes receiving the clearing batch file from an acquirer associated with the entity; and
wherein causing the identified interchange rate designator to be included in the clearing batch file includes appending, by the computing device, the identified interchange rate designator to the clearing batch file for the network transaction.

4. The computer-implemented method of claim 3, wherein appending the identified interchange rate designator to the clearing batch file includes replacing a prior interchange rate designator in the clearing batch file for the network transaction.

5. The computer-implemented method of claim 1, wherein searching in the data structure includes searching in the data structure for criteria associated with multiple interchange rate designators that satisfy one or more of the details of the network transaction; and
wherein identifying the interchange rate designator includes selecting one of the multiple interchange rate designators in the data structure that satisfy the one or more of the details of the network transaction and that is associated with a lower rate than any other of the multiple interchange rate designators that satisfy the one or more of the details of the network transaction.

6. The computer-implemented method of claim 1, further comprising advising an acquirer associated with the network transaction of the identified interchange rate designator when an interchange rate designator assigned by the acquirer is different that the identified interchange rate designator.

7. The computer-implemented method of claim 1, further comprising identifying at least one interchange rate designator as an opportunity for an acquirer associated with the entity, when one or more of the details of the network transaction satisfies at least one of multiple criteria associated with the at least one interchange rate designator, but not all of the multiple criteria associated with the at least one interchange rate designator.

8. A system for identifying interchange rate designators for payment account transactions, the system comprising:
a memory including a data structure having multiple interchange rate designators and criteria associated therewith; and
a processor in communication with the memory and configured, by executable instructions stored in the memory, to:
search in the data structure for details of a transaction associated with a merchant, at least one of the details including a region identifier for the merchant;
identify at least one interchange rate designator for the transaction from the data structure, the at least one interchange rate designator including a criteria that satisfies at least the region identifier for the merchant; and
cause the identified at least one interchange rate designator to be included in a clearing batch file for the transaction, whereby the transaction can be submitted for clearing and settlement with the identified at least one interchange rate designator associated with the transaction.

9. The system of claim 8, wherein the processor is further configured, by the executable instructions, to receive the details of the transaction from an acquirer associated with the merchant, the details further including an interchange rate designator assigned to the transaction by the acquirer.

10. The system of claim 9, wherein the processor is further configured, by the executable instructions, to advise the acquirer of the identified at least one interchange rate designator when the identified at least one interchange rate designator is different than the interchange rate designator assigned to the transaction by the acquirer.

11. The system of claim 10, wherein the processor is configured, by the executable instructions, in connection with receiving the details of the transaction from the acquirer, to receive the clearing batch file from the acquirer, the clearing batch file including the interchange rate designator assigned to the transaction by the acquirer.

12. The system of claim 11, wherein the processor is configured, by the executable instructions, in connection with causing the identified at least one interchange rate designator to be included in the clearing batch file for the transaction, to replace, in the clearing batch file, the interchange rate designator assigned to the transaction by the acquirer with the identified at least one interchange rate designator.

13. The system of claim 8, wherein the processor is configured, by the executable instructions, in connection with identifying the at least one interchange rate designator for the transaction from the data structure, to identify multiple interchange rate designators, each of the multiple interchange rate designators associated with a rate; and
wherein the processor is further configured, by the executable instructions, to select one of the multiple interchange rate designators having a lowest rate.

14. The system of claim 9, wherein the processor is configured, by the executable instructions, in connection with receiving the details of the transaction from the acquirer, to receive a request from the acquirer; and
wherein the processor is configured, by the executable instructions, in connection with causing the identified at least one interchange rate designator to be included in the clearing batch file for the transaction, to transmit the identified at least one interchange rate designator to the acquirer, thereby permitting the acquirer to append the identified at least one interchange rate designator to the clearing batch file.

15. A non-transitory computer-readable storage media including executable instructions for identifying interchange rate designators for network transactions, which, when executed by at least one processor, cause the at least one processor to:
receive details of a transaction associated with a merchant, the details including at least a region identifier for the merchant;
search for and identify, in an interchange rate data structure, an interchange rate designator for the transaction based at least on the region identifier associated with the transaction satisfying a corresponding region criteria of the interchange rate designator; and
identify the interchange rate designator as an opportunity for an acquirer associated with the merchant when the details of the transaction fail to satisfy all criteria associated with the interchange rate designator.

16. The computer-readable storage media of claim 15, wherein the executable instructions, when executed by the at least one processor, further cause the at least one processor to cause the identified interchange rate designator to be included in a clearing batch file for the transaction when the details of the transaction satisfy all of the criteria associated with the interchange rate designator, whereby the transaction is submitted for clearing and settlement with the identified interchange rate designator associated with the transaction.

17. The computer-readable storage media of claim 16, wherein the executable instructions, when executed by the at least one processor in connection with receiving the details of the transaction, causes the at least one processor to receive the clearing batch file from an acquirer associated with the merchant; and
wherein the executable instructions, when executed by the at least one processor in connection with causing the identified interchange rate designator to be included in the clearing batch file, causes the at least one processor to append the identified interchange rate designator to the clearing batch file for the transaction.

18. The computer-readable storage media of claim 17, wherein the clearing batch file includes an interchange rate designator assigned to the transaction by the acquirer; and
wherein the executable instructions, when executed by the at least one processor in connection with appending the identified interchange rate designator to the clearing batch file, causes the at least one processor to replace, in the clearing batch file, the interchange rate designator assigned to the transaction by the acquirer with the identified interchange rate designator.

19. The computer-readable storage media of claim 16, wherein the executable instructions, when executed by the at least one processor in connection with receiving the details of the transaction, causes the at least one processor to receive a request from the acquirer; and
wherein the executable instructions, when executed by the at least one processor in connection with causing the identified at least one interchange rate designator to be included in the clearing batch file for the transaction, to transmit the identified at least one interchange rate designator to the acquirer, thereby permitting the acquirer to append the identified at least one interchange rate designator to the clearing batch file.
